(19) United States
(12) Patent Application Publication
(10) Pub. No.: US 2011/0001379 A1
(43) Pub. Date: Jan. 6, 2011

(54) PASSIVE MAGNETIC BEARING

(75) Inventors: Sean McCarthy, Dublin (IE); Seamus Flanagan, County Kildare (IE); Alan Simpson, Dublin (IE); Maxime Sorin, Dublin (IE)

Correspondence Address: SEYFARTH SHAW LLP, WORLD TRADE CENTER EAST, TWO SEAPORT LANE, SUITE 300, BOSTON, MA, 02210-2028, US

(73) Assignee: Steorn Limited, Dublin (IE)

(21) Appl. No.: 12/829,457

(22) Filed: Jul. 2, 2010

Related U.S. Application Data
(60) Provisional application No. 61/222,507, filed on Jul. 2, 2009.

(51) Int. Cl. H02K 7/09

(52) U.S. Cl. 310/90.5

(57) ABSTRACT

A passive magnetic bearing which has an exceptionally low friction couple. Radial and axial restraint is achieved through magnetic and mechanical means. The embodiment of the passive magnetic bearing has two axially magnetized rings, which each exhibit at least one pair of north and south poles. The magnetized rings are positioned in a manner where the poles are in a repulsive magnetic interaction such that the plane of symmetry which separates the like poles lies perpendicular to the axis of the rotation of a shaft and this radially constrains the movement of the shaft. Axial rigidity is added to the system by the use of ceramic bearings and related axial retaining mechanisms on one of the ring magnets thus maintaining the magnetic bearing in an otherwise unstable axial plane.

### FIELD OF THE INVENTION

The present invention is in the field of bearings systems, and more particularly relates to passive magnetic bearings for providing radial and axial restraint in rotary systems.

### BACKGROUND OF THE INVENTION

This invention relates to control of rotating mechanical systems, specifically the requirement to restrain the relative movement of two or more elements of such a system. A wide variety of bearings exist which attempt to address this requirement, ranging from simple ball bearings to complex electromagnetic assemblies.

Ball bearings are well known in the art and are utilized in thousands of devices. Improvements in materials technology, such as the use of ceramics, and enhanced raceway designs have addressed many of the inherent issues with traditional bearings, such as friction and lubrication.

At the other end of the spectrum, advances in magnetic materials and magnetic levitation technology have given rise to active magnetic bearings which overcome the issues associated with direct contact between moving parts although they present a different set of challenges related to their complex control requirements.

### SUMMARY OF THE INVENTION

The invention disclosed herein relates to a means of providing radial and axial stability using passive magnetic bearings in conjunction with ceramic ball bearings and associated structures.

The passive magnetic bearings disclosed herein have an exceptionally low friction couple whilst exhibiting radial and axial rigidity.

In one illustrative embodiment, passive magnetic bearing is made up of a large axially magnetized ring shaped magnet, and a less large axially magnetized ring shaped magnet. Both magnets have at least one pair of negative and positive poles with field lines which emanate in an axial manner, that is, a magnetic field shape which is perpendicular to an axial cross section of the magnets.

When the less large magnetic ring is positioned inside the open area of the large magnetic ring, the field of the less large magnetic ring and the magnetic field of the large magnetic ring will rapidly produce both a restorative and repulsive force such that a levitation effect will be acting upon the less large magnetic ring compared to the large magnetic ring.

The large magnetic ring is embedded in a non-magnetic material and this housing is designed so that no displacement of the housing or the large magnetic ring is allowed. The housing also allows for the less large ring magnet to sit directly within the internal open area of the larger ring magnet. The less large ring magnet is restrained by the following mechanisms: two sets of stainless steel axial thrust bearings and a number of ceramic ball bearings, all of which are housed in two cages.

The resultant precise positioning of the less large ring magnet is such that the two ring magnets have their positive and negative poles aligned such that the net forces, or lines of force, acting between the magnetic rings are close to or equal to zero. Any displacement experienced by the less large ring magnet is mechanically corrected by the ceramic bearings in conjunction with a magnetic correction relating to the opposing fields of the two ring magnets seeking their lowest energy or force state, thus realigning the less large magnetic ring back to a predetermined home position.

This system is of a magneto-mechanical nature and requires no circuitry. It has a variety of applications which require a friction minimizing bearing operation. The removal of friction through the levitation effect exhibited by this magnetic bearing system through the non-contact nature of the shaft and its attached less large ring magnet, coupled with the passive nature of this system, allows for non-contact rotation for both low and high speed systems integration.

One of the known impediments to such a system is eddy current losses and to counter these, materials within the system are chosen for their lack of conductivity and/or are of a high electrical resistivity value. Another issue typical of a magnetic bearing system is losses due to hysteresis effects which in turn are due to changing magnetic fields. Such hysteresis effects are removed or minimized to such an extent that they are not a significant loss due to reduced magnetic field changes directly related to the fact that the large and less large ring magnets are radially restrained in a stable repulsive magnetic field by said magnetic field interaction and also that the axial movement of the less large ring magnet is substantially reduced, such that the overall magnetic bearing systems operates in a manner that allows for a near zero force to be acting on the two ring magnets and as such the system exhibits little or no magnetic field changes and thus little or no hysteresis effects or losses.

Due to the rigid nature of this magnetic bearing system, this system can be used as a single unit or in a plurality of implementations and the related magnetic levitation of the shaft allows for little or no contact on the shaft pivot points, thereby vastly reducing or completely diminishing pivot point friction.

### BRIEF DESCRIPTION OF THE DRAWINGS

FIG. 1 is a cross section of the bearing system.

FIG. 2 is a cross section of the large and less large ring magnets indicating their polar orientation.

FIG. 3 shows a first, less large inner magnet, its attached stainless steel sleeve and an attached shaft.

FIG. 4 shows the less large inner magnet, its attached stainless steel sleeve and an attached shaft for a dual bearing arrangement.

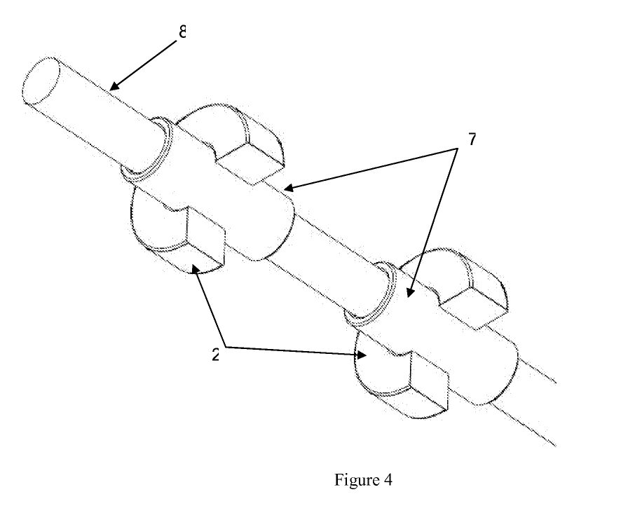

FIG. 5 is a cross section of the bearing system without its outer housing.

### DETAILED DESCRIPTION

In accordance with one embodiment of the present invention a large axially magnetized ring magnet 1 and a less large axially magnetized ring magnet 2 are positioned inside a housing 6. The housing 6, manufactured from Acetal, is circular in shape with a diameter of 43 mm and a depth of 9 mm comes in two pre-manufactured parts, which are mirror images of each other. Each housing piece exhibits three step-down cut outs. The largest of these is found 8 mm from the outer diameter of the housing piece. This first cut out has a diameter of 30 mm, the second largest cut out has a diameter of 24.4 mm and the smallest has a diameter of 11.5 mm. It is within these cut outs in this illustrative embodiment that the various bearing components are housed.

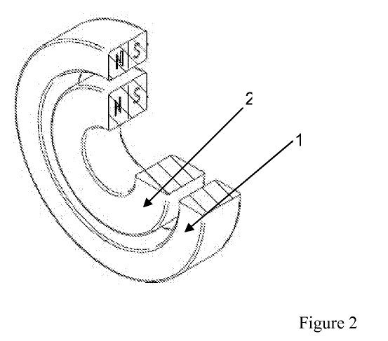

As shown in FIG. 2 the two ring magnets 1 and 2 exhibit at least one pair of north and south poles. The two magnets 1 and 2 have the same width and are constrained within the housing such that the both the outer and inner edges of the ring magnets are in the same y plane symmetry. The magnets 1 and 2 are positioned in such a manner that they exert a repulsive magnetic field on each other. In this embodiment the outer diameter for the large magnet 1 is 30 mm, its inner diameter is 22 mm and its depth is 6 mm. For the less large magnet 2, its outer diameter is 18.6 mm, its inner diameter is 8.2 mm and its depth is 6 mm. Both the large ring magnet 1 and the less large ring magnet 2 are made from NdFeB 35 material.

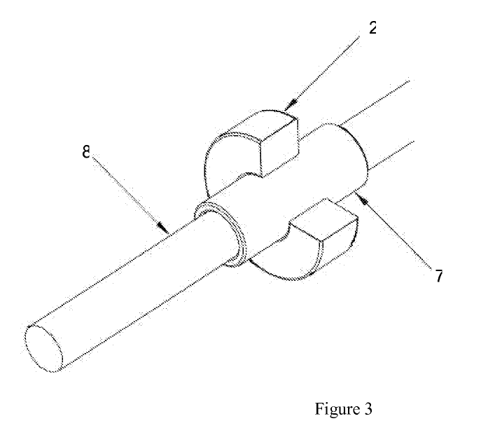

FIG. 2. and FIG. 3 illustrate the magnetic pole positions of the two ring magnets, which is such that a restorative force is acting between the two magnetic bodies 1 and 2 so that they are magnetically and mechanically restrained in this predetermined position. This effect allows for a shaft 8 (FIG. 3), which is attached to the less large magnetic ring 2 by way of a stainless steel sleeve 7. The stainless steel sleeve 7 is made of stainless steel 316, and has an outer diameter of 8.2 mm, an inner diameter of 6 mm and is 20 mm in length.

It follows that a levitation effect is experienced by the shaft 8 which is radially constrained by both the levitation effect and the restorative magnetic effect outlined in this particular embodiment of this invention. That is to say that where the radial displacement of the centre of the less large ring magnet 2 is zero from the centre of the large ring magnet 1 then the force acting on the less large ring magnet 2 is zero Newtons.

The radial stiffness of this system is inversely proportional to the air gap between the large ring magnet 1 and less large magnetic ring 2, and its associated stainless steel sleeve 7 with its attached shaft 8. That is to say that the smaller the air gap between the ring magnets 1 and 2, the lower the propensity of the less large ring magnet 2 and its associated stainless steel sleeve 7 with its attached shaft 8, to experience radial displacement. Accordingly the spring constant is at its most beneficial level at this air gap which is fixed consequently in conjunction to achievement of an invariant total system magnetic field whether the magnetic materials, with their inherent magnetic fields, of the combined fields are in a stationary position or rotational plane of movement. The spring constant deals in this particular embodiment with the relationship between the distance of the two ring magnets, 1 and 2, and the force required to restore any radial displacement of said magnetic rings.

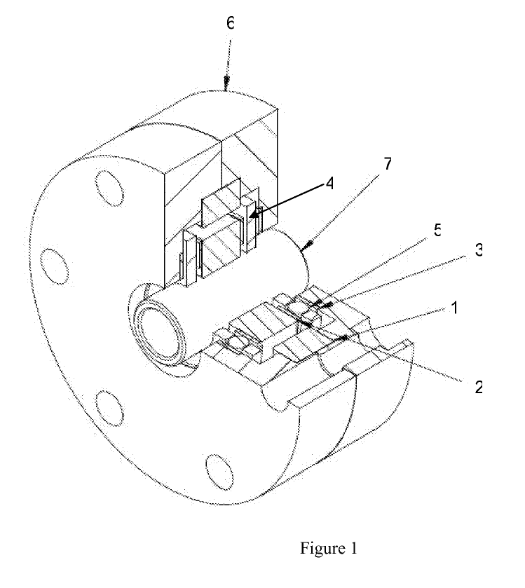

Referring back to FIG. 1 the large ring magnet 1 is constrained in the housing 6 by a thrust bearing race 3 with non-magnetic ball bearings 5. The ball bearings are of a 3/32 in diameter and are of an aluminum oxide material, whilst the thrust bearing race is of a stainless steel material and has an outer diameter of 18.5 mm, an inner diameter of 11.5 mm and a depth of 0.5 mm.

The ball bearings 5 are kept in place by two cages 4 of Acetal material, each cage 4 having a total of 10 cavities of 2.6 mm diameter. Each cage 4 has an outer diameter of 21 mm and an inner diameter of 15 mm, and each of the centre-points of the cavities is exactly 8.5 mm from the centre-point of the cage. Each of the cavities has one of the ball bearings 5 free to move about it. The friction for such rolling or sliding of the ball bearings 5 is facilitated by the thrust bearing race 3.

The configuration of thrust bearing races 3, ball bearings 5, and cages 4 is such that the less large ring magnet 2 is kept in a stable axial position with respect to maintaining an invariant field between the large 1 and less large 2 axially magnetized ring magnets.

There are a total of four thrust bearing races 3 incorporated into the passive magnetic bearing system. Each thrust bearing race 3 has an outer diameter of 18.5 mm and an inner diameter of 11.5 mm. These are permanently affixed by adhesive to the two sections of housing 6. The thrust bearing races 3 provide the minimum surface friction for the ceramic ball bearings to operate to maintain the less large magnetic ring 2 and its associated stainless steel sleeve in 7 a stable axial position.

For the correct operation of the ball bearings 5 there is a requirement for a set of thrust bearing races 3 to be utilized on both contact sides for the ball bearings 5. For this particular arrangement, a total of twenty 3/32 in aluminum oxide ball bearings are used.

The number of ball bearings, thrust bearing race diameter, and holding cage size is directly dependent on the choice of ring magnets, being reliant on the physical dimensions of the magnetic materials, the grades, the resultant magnetic field shapes and the required air gap to maintain the levitation effect in a radial manner, as presented previously. The size of any proposed rotor or shaft to be attached to the system is also a function of material and specification choice.

The retaining mechanisms, the small magnetic ring 2 and similar are attached using adhesive to the stainless steel sleeve 7 of an outer diameter of 8.2 mm and an inner diameter of 6 mm. A shaft 8 would in turn be attached to the inner diameter of the sleeve, typically by welding or an adhesive of sufficient strength to maintain required operation.

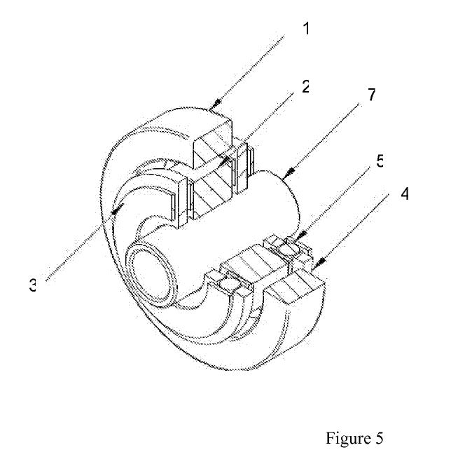

Further magnetic bearing systems of the same specification could be added to a shaft 8, as per FIG. 5, where the components are set out in a dual system arrangement. Attaching more than one magnetic bearing system gives radial and axial rigidity which is such that the shaft 8 can achieve levitation and be stable in a permanent manner such that there is no contact between the shaft 8 and the large ring magnet 1.

FIG. 6 shows the components of the axial retaining system for the less large ring magnet 2 and in turn the positional relationship of the less large ring magnet 2 with the large ring magnet 1. The magnetization field directions illustrate the fact that the two magnets are in repulsive mode and this setting has both retentive and restorative magnetic and mechanical characteristics.

While the invention has been described with reference to illustrative embodiments, it will be understood by those skilled in the art that various other changes, omissions, and/or additions may be made and substantial equivalents may be substituted for elements thereof with departing from the spirit and scope of the invention. In addition, many modifications may be made to adapt a particular situation or material to the teaching of the invention with departing from the scope thereof. Therefore, it is intended that the invention not be limited to the particular embodiment disclosed for carrying out this invention, but that the invention will include all embodiments, falling within the scope of the appended claims.

What is claimed is:

1. A passive bearing system comprising a pair of axially magnetized ring shaped magnets, said pair of magnets being a large and a less large magnetic ring; a set of thrust races, ball bearings and cages to hold same.

2. The bearing system of claim 1 where the radial restraint is provided by magnetic means through the use of the ring magnets.

3. The bearing system of claim 1 where the axial restraint is provided by mechanical means through the use of the ball bearings and associated assemblies.

4. The bearing system of claim 1 wherein said system exhibits an exceptionally low friction couple.

5. The bearing system of claim 1 wherein said system offers substantial radial and axial restraint.

6. The bearing system of claim 1 wherein said system offers substantial radial restraint.

7. The bearing system of claim 1 wherein said system offers substantial axial restraint.

8. The bearing system of claim 1 where the ring magnets assembly rapidly produces both a restorative and repulsive force such that a levitation effect will be acting upon the less large magnetic ring compared to the large magnetic ring.

9. The bearing system of claim 1 where the ring magnets are positioned in such a manner that their repulsive poles are placed at the point of greatest repulsion such that the repulsed poles rest in an area of zero force through a cancellation effect and in turn that the axis of the shaft lies perpendicular to said repulsive poles allowing near non-contact levitation by the shaft being attached to the less large magnetic ring.

10. The bearing system of claim 1 where the less large axially magnetized ring and an associated shaft exhibit a very low axial displacement and related friction and thus a strong axial retention on the shaft by the utilization of ball bearings and related retaining mechanisms which operate in conjunction with the zero force aspects of the system outlined in claim 9.
